(19) United States
(12) Patent Application Publication
(10) Pub. No.: US 2024/0381844 A1
(43) Pub. Date: Nov. 21, 2024

(54) PET TREAT TOY

(71) Applicant: The Kyjen Company, LLC, Centennial, CO (US)

(72) Inventors: Danielle Salyer, Denver, CO (US); Jeffrey Paris, Los Angeles, CA (US); Jared Mosher, Arvada, CO (US); Chaz Ozzello, Englewood, CO (US)

(21) Appl. No.: 18/666,764

(22) Filed: May 16, 2024

Related U.S. Application Data
(60) Provisional application No. 63/466,888, filed on May 16, 2023.

(51) Int. Cl. A01K 15/02; A01K 5/02

(52) U.S. Cl. CPC A01K 15/025; A01K 5/0233

(57) ABSTRACT

Provided is a pet toy including a base having a basin and a chute extending from the basin, a cover removable coupled to the base, and at least one extendable assembly including an actuator. The at least one extendable assembly is configured to extend into the basin toward a center of the basin and capture food for a pet when the actuator is depressed and to haul the captured food to the chute when the actuator is released.

This application claims the benefit of priority to U.S. Provisional Application entitled “Pet Treat Toy,” filed on May 16, 2023, and assigned Ser. No. 63/466,888, the entire disclosure of which is hereby expressly incorporated by reference.

### BACKGROUND OF THE DISCLOSURE

### Field of the Disclosure

The disclosure relates generally to pet toys, and more specifically, to interactive pet toys configured to mentally stimulate pets.

### Brief Description of Related Technology

Generally, a wide variety of pet toys are available to keep pets entertained. For example, pet toys including one or more of a squeaker, a bell, crinkle paper, and the like may be configured to make noise, entertaining pets. Some pet toys engage and entertain pets by dispensing treats. Other pet toys include balls, frisbees, wands, toys including treats (e.g., cat nip, pet treats), chew toys, and the like. However, after time, pets may become disinterested in their toys. Accordingly, there is a need for new and unique pet toys that provide interactive and dynamic playing experience that engage pets for longer periods of time.

### SUMMARY OF THE DISCLOSURE

In accordance with one aspect of the present disclosure, a pet toy includes a base having a basin and a chute extending from the basin, a cover removably coupled to the base, and at least one extendable assembly including an actuator. The at least one extendable assembly is configured to extend into the basin toward a center of the basin and capture food for a pet when the actuator is depressed and to haul the captured food to the chute when the actuator is released.

In accordance with another aspect of the present disclosure, a pet toy includes a base having a basin, an outlet, and a chute extending between the basin and the outlet, and an extendable assembly. The extendable assembly includes an actuator rotatably coupled to the base, a linking member rotatably coupled to the actuator, and a hollow structure rotatably coupled to the linking member. The extendable assembly is configured to move from a starting arrangement to an extended arrangement when a downward force is applied to the actuator. Additionally, the extendable assembly is configured to move from the extended arrangement to the starting arrangement when the actuator is released. The hollow structure is configured to capture food disposed in the basin as the extendable assembly moves from the starting arrangement to the extended arrangement and to haul the captured food to the chute when the extendable assembly moves from the extended arrangement to the starting arrangement.

In accordance with yet another aspect of the present disclosure, a pet toy includes a base including a basin and a chute extending from the basin, a cover removably coupled to the base, and a pair of extendable assemblies coupled to the base. Each of the pair of extendable assemblies includes an actuator and is configured to extend into the basin and capture food for a pet when the actuator is depressed and haul the captured food to the chute when the actuator is released.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates a perspective view of a pet toy in accordance with one example of the present disclosure.

FIG. 2 illustrates a cross sectional view of the pet toy of FIG. 1 in accordance with one example of the present disclosure.

FIG. 3 illustrates an exploded view of an extendable assembly in accordance with one example of the present disclosure.

FIG. 4 illustrates a partial cross sectional view of a first state of the extendable assembly of FIG. 3 in accordance with one example of the present disclosure.

FIG. 5 illustrates a partial cross sectional view of a second state of the extendable assembly of FIG. 3 in accordance with one example of the present disclosure.

FIG. 6 illustrates a partial cross sectional view of a third state of the extendable assembly of FIG. 3 in accordance with one example of the present disclosure.

FIG. 7 illustrates a partial cross sectional view of a fourth state of the extendable assembly of FIG. 3 in accordance with one example of the present disclosure.

FIG. 8 illustrates a partial cross sectional view of the pet toy of FIG. 1 in accordance with one example of the present disclosure.

FIG. 9 illustrates a perspective view of a cover of the pet toy of FIG. 1 in accordance with one example of the present disclosure.

FIG. 10 illustrates a first state of an elastic member of a pet toy in accordance with one example of the present disclosure.

FIG. 11 illustrates a second state of an elastic member of the pet toy of FIG. 10 in accordance with one example of the present disclosure.

FIG. 12 illustrates a third state of an elastic member of the pet toy of FIG. 10 in accordance with one example of the present disclosure.

While the disclosed pet toys and methods are susceptible of embodiments in various forms, there are illustrated in the drawings (and will hereafter be described) specific embodiments of the disclosure, with the understanding that the disclosure is intended to be illustrative and is not intended to limit the disclosure to the specific embodiments described and illustrated herein.

### DETAILED DESCRIPTION OF THE DISCLOSURE

The present disclosure is provided to solve the above-mentioned problems in the Background of the Disclosure section. Specifically, the present disclosure provides an interactive pet toy including a base having a basin configured to hold food (e.g., treats, kibble) for pets, a cover removable coupled to the base, and at least one extendable assembly including an actuator, the extendable assembly configured to extend into the basin and capture food for a pet when the actuator is depressed and haul the food to a chute for dispensing the food when the actuator is released.

According to the present disclosure, the cover may be removably coupled to the base allowing a human to remove the cover and place food (e.g., treats, kibble) for a pet in the basin. The cover may prevent pets from eating or taking food directly from the basin of the pet toy, encouraging pets to operate the actuator, for example, pressing and subsequently releasing the actuator causing the extendable assembly to extend toward the center of the basin, capture food, and haul food to the chute, such that food is dispensed from the base of the pet toy. The cover may advantageously be comprised of a transparent material allowing pets to see food within the basin and/or include one or more scent holes allowing pets to more easily smell food disposed within the basin.

In some examples, an interactive pet toy according to the present disclosure may include two or more extendable assemblies. The extendable assemblies may be disposed, for example, on opposite sides of the base or on each side of the base. The pet toy may advantageously include multiple extendable assemblies allowing two or more pets to each play with the pet toy. For example, two or more pets may each operate an actuator of a respective extendable assembly, for example, competing with one another to obtain treats disposed within the basin using the respective extendable assemblies.

According to some examples, an extendable assembly may include an actuator rotatably coupled to the base, a linking member rotatable coupled to the actuator, and a hollow structure rotatably coupled to the linking member. The linking member may extend between the actuator and the hollow structure. Opposite ends of the linking member may be coupled to the actuator and the hollow structure. In some examples, the linking member may include a post extending laterally, in a direction perpendicular to motion of the linking member, from a side of the linking member. In these examples, the basin may include a bottom panel including an opening extending between the basin and the chute. The base may further include a guide portion extending downward from the bottom panel along the opening and a guide wall extending from the guide portion toward a center of the opening. In these examples, as the actuator is depressed, the post of the linking member may contact a bottom surface of the guide wall, such that the guide wall dictates or controls a position of the linking member, and thus an arrangement of the extendable assembly as the linking member moves toward a center of the basin.

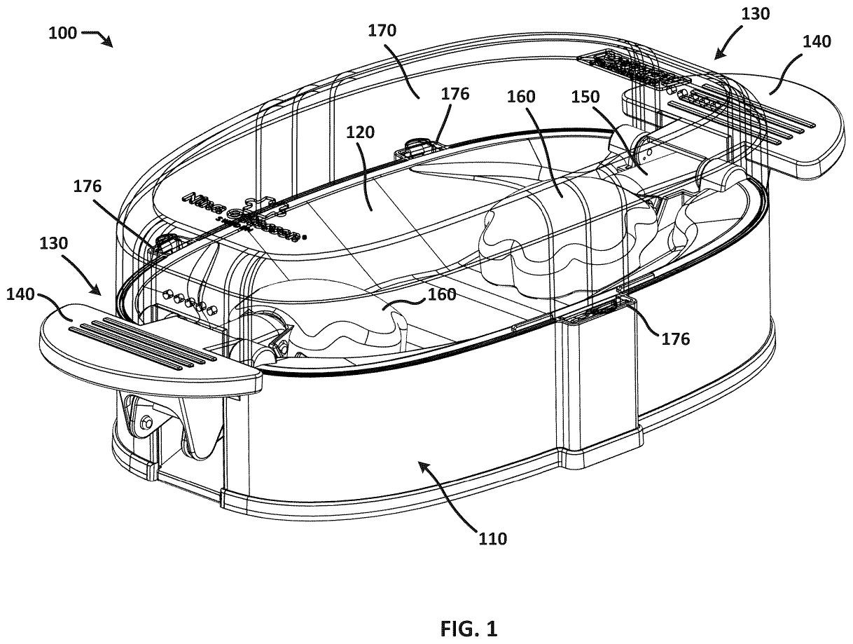

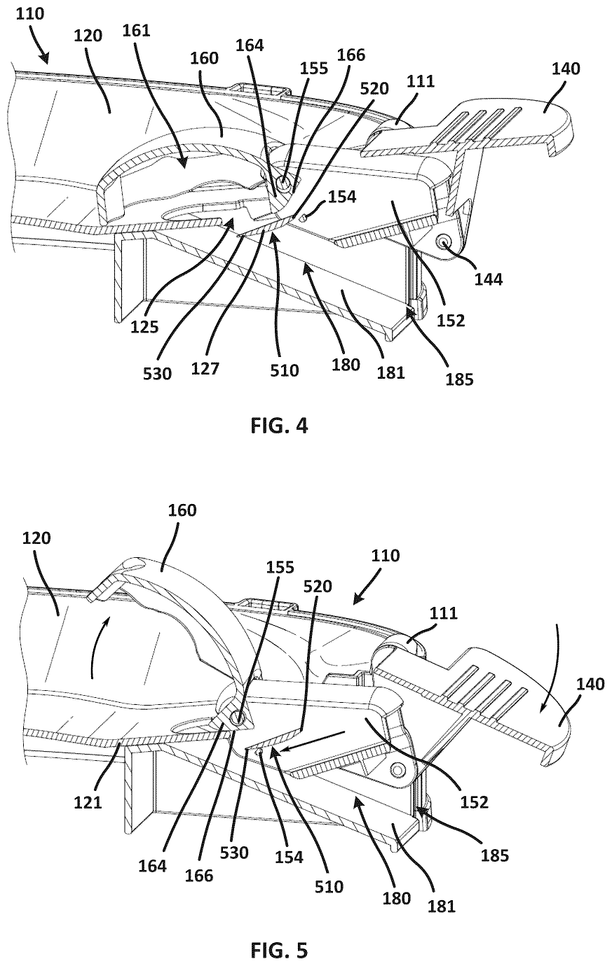

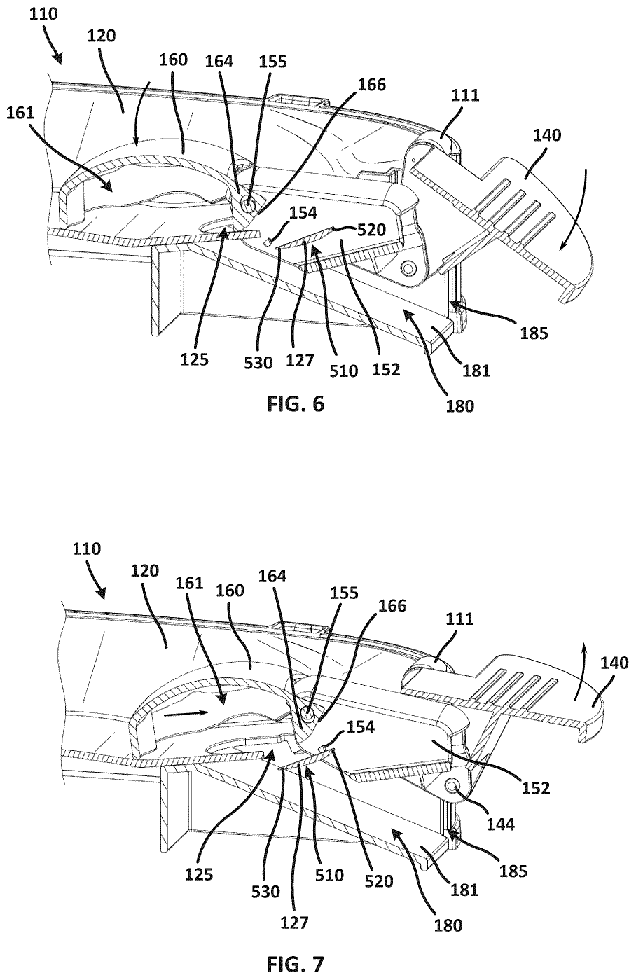

Referring to FIG. 1, a perspective view of a pet toy 100 according to one example of the present disclosure is illustrated. As shown in FIG. 1, the pet toy 100 includes a base 110 having a basin 120, and at least one extendable assembly 130 coupled to the base 110. The at least one extendable assembly 130 may include an actuator 140, a linking member 150, and a hollow structure 160. The example shown in FIG. 1 includes two extendable assemblies 130. Each extendable assembly 130 may be configured to move between a starting arrangement, as shown in FIG. 1, and an extended arrangement (see FIG. 6). Each extendable assembly 130 may be configured to capture food for a pet disposed in the basin 120 as the extendable assembly 130 moves from the starting arrangement to the extended arrangement and haul the captured food to a chute for dispensing the food as the extendable assembly 130 moves from the extended arrangement to the starting arrangement. Operation and movement of an extendable assembly 130 is described hereinafter in greater detail with respect to FIGS. 4-7.

In some examples, as shown in FIG. 1, the pet toy 100 may include two extendable assemblies 130. However, the present disclosure is not limited thereto and the pet toy 100 may include any number of extendable assemblies 130. For example, the pet toy 100 may include one, two, three, four, or more than four extendable assemblies 130. The extendable assemblies 130 may be disposed or located on different, for example, opposite sides of the base 110. In some examples, an extendable assembly 130 may be included at each side of the base 110.

As shown in FIG. 1, the pet toy 100 may include a cover 170 removably coupled to the base 110. The cover 170 may be removably coupled to the base 110, such that a human can remove the cover to place food (e.g., treats, kibble) for a pet in the basin 120. The cover 170 may then be coupled to the base 110, such that a pet cannot directly access food disposed in the basin 120 (e.g., so as to eat or otherwise remove the food from the basin 120). The cover 170 is described hereinafter in greater detail with respect to FIG. 9.

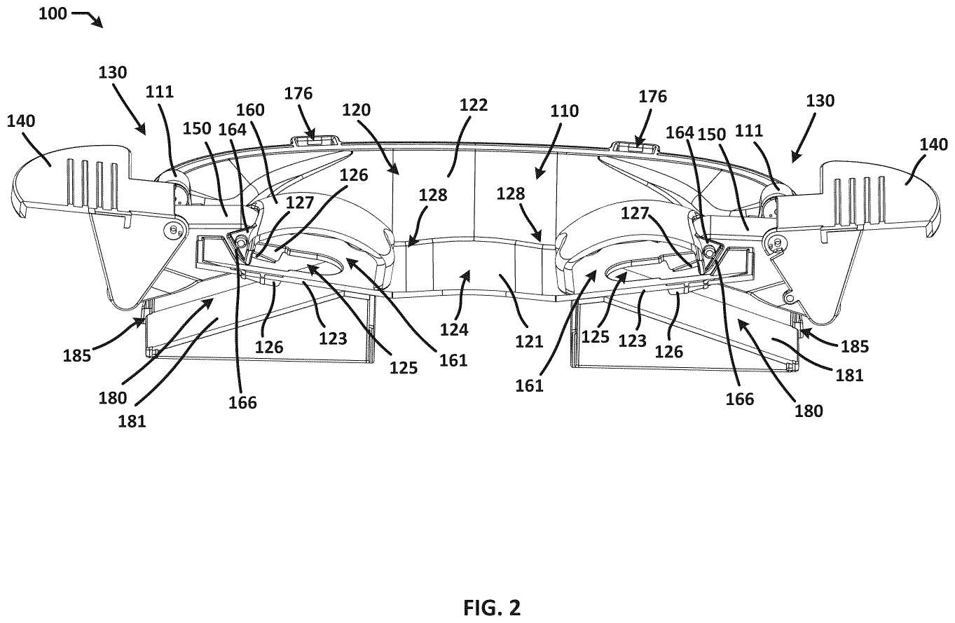

Referring to FIG. 2, a cross sectional view of the pet toy 100 without a cover 170 is illustrated in accordance with one example of the present disclosure. As shown in FIG. 2, the basin 120 may include a basin bottom wall or panel 121 (e.g., basin bottom panel 121 or simply bottom panel 121) and one or more side walls or panels 122 (e.g., basin side panel 122 or simply side panel 122). The side panel(s) 122 may extend upward and outward from the bottom panel 121, for example, so as to be disposed or orientated at an oblique angle with respect to the bottom panel 121. The basin 120 may be configured to hold food (e.g., treats, kibble) for pets. Specifically, the bottom panel 121 may support food resting on a top surface of the bottom panel 121 and disposed in the basin 120.

According to some examples of the present disclosure, as shown in FIG. 2, the bottom panel 121 may include an angled portion 123 disposed proximate to an (e.g., each) extendable assembly 130. The angled portion 123 may be configured to direct food away from a periphery of the basin 120 toward a center of the basin 120 where the food is more likely to be captured by the extendable assembly 130. As shown in FIG. 2, the angled portion 123 may slope downwardly toward a center of the basin 120. The angled portion 123 may be configured to influence or bias food (e.g., disposed on the angled portion 123) to slide, roll, or otherwise move toward a center of the basin 120. Specifically, the slope of the angled portion 123 may cause food disposed on the angled portion 123 to slide or roll toward a center of the basin 120, such that food (e.g., treats, kibble) having an irregular or oblong (e.g., substantially non-spherical) shape may slide, roll, or otherwise travel down the angled portion 123 toward a center of the basin 120 and not get hung up or become stationary between the opening 125 and the capture region 128, as discussed below. The angled portion 123 may be disposed at a sufficiently steep angle, such that sliding friction of the food is overcome, and thus, the food slides down the angled portion 123.

In some examples, as shown in FIG. 2, the bottom panel 121 may include one or more elevated portions 124 including a sloped surface. For example, the bottom panel 121 may include an elevated portion 124 disposed at a center of the basin 120. The one or more elevated portions 124 may be configured to influence or bias food (e.g., disposed on the elevated portion 124) to slide off, roll off, or otherwise move from the elevated portion 124. Specifically, the sloped surface of the elevated portion 124 may cause food disposed on the elevated portion 124 to slide or roll off of the elevated portion 124. The elevated portion 124 may be designed and configured such that pet treats (e.g., food, kibble) do not rest on top of the elevated portion 124 out of reach of the extendable assemblies 130. The sloped surface of the elevated portion 124 may be disposed at a sufficiently steep angle, such that sliding friction of the food is overcome, and thus, the food slides down the sloped surface of the elevated portion 124.

In some examples, as shown in FIG. 2, the basin 120 may include a capture region 128. As shown in FIG. 2, the capture region 128 may be an area or region of the basin 120 in which the bottom panel 121 is disposed at a relatively low elevation (e.g., above a surface on which the pet toy 100 rests) as compared to other areas or regions of the basin 120. While an extendable assembly 130 may be capable of capturing food within the basin 120 disposed at locations or in regions other than the capture region 128, the capture region 128 may be an area or region of the basin 120 in which food is most likely to be captured by the extendable assembly 130. A capture region 128 may be disposed, for example, as shown in FIG. 2, between an angled portion 123 of the bottom panel 121 and an elevated portion 124 of the basin 120.

The bottom panel 121 of the basin 120 may include an opening 125. In some examples, as shown in FIG. 2, the opening 125 may be disposed below the hollow structure 160 of the extendable assembly 130 when the extendable assembly 130 is in the starting arrangement. In some examples, the opening 125 may be disposed in an angled portion 123 of the bottom panel 121 of the basin 120. The opening 125 may be disposed between the basin 120 to a channel or chute 180 disposed in the base 110. The chute 180 may extend between the opening 125 and an outlet 185 configured to dispense food to an exterior of the base 110. The chute 180 may include a bottom surface 181 (e.g., chute bottom surface 181) disposed below the opening 125. In some examples, the chute 180 may include an oblique bottom surface 181 (e.g., with respect to a surface supporting the pet toy 100) extending from a top side disposed below the opening 125 to a bottom side disposed at an outlet 185 of the pet toy 100. Specifically, the chute 180 may have an angled bottom surface 181, such that food disposed within the chute 180 (e.g., on the bottom surface 181) travels (e.g., slides, rolls) down the chute 180 to the outlet 185 and, for example, is subsequently dispensed from the base 110 through the outlet 185.

According to some examples, as shown in FIG. 2, the bottom panel 121 of the basin 120 may be elevated above a surface on which the pet toy 100 rests. According to some examples, the bottom panel 121 of the basin 120 may be disposed a certain distance above a surface on which the pet toy 100 rests, such that a chute 180 including a bottom surface 181 having a sufficiently steep slope such that food (e.g., treats, kibble) having an irregular or oblong (e.g., substantially non-spherical) shape may slide, roll, or otherwise travel down the chute bottom surface 181. Specifically, in some examples, because of an irregular or oblong (e.g., substantially non-spherical shape) of the food, the food may not roll down the bottom surface 181 of the chute 180, but instead may slide down the bottom surface 181 of the chute 180. Accordingly, the bottom surface 181 of the chute 180 must be disposed at a sufficiently steep angle such that sliding friction of the food is overcome, and thus the food slides down the bottom surface 181. According to some examples, the bottom surface 181 of the chute 180 may be disposed at an angle of 15 degrees or greater with respect to a surface on which the pet toy 100 rests. In other examples, the bottom surface 181 of the chute 180 may be disposed at an angle of 16 degrees or greater, 17 degrees or greater, or 18 degrees or greater with respect to a surface on which the pet toy 100 rests. The angle at which the bottom surface 181 of the chute 180 is disposed may be in the range of 15-45 degrees, 15-30 degrees, 15-25 degrees, or 15-20 degrees.

In some examples, the bottom panel 121 may include a guide portion 126 and a guide wall 127 configured to facilitate operation (e.g., movement) of the extendable assembly 130. The guide portion 126 may extend downward from the bottom panel 121. For example, as shown in FIG. 2, the guide portion 126 may extend downward from the bottom panel 121 along a portion of the opening 125 of the basin bottom panel 121. As shown in FIG. 2, the bottom panel 121 may include two or more guide portions 126. The guide portions 126 may be disposed on opposite sides of the opening 125. As shown in FIG. 2, each guide portion 126 may include a guide wall 127 extending from the guide portion 126. The guide wall 127 may extend inward toward a center of the opening 125. The guide portion 126 and guide wall 127 will be described hereinafter in greater detail with respect to FIGS. 4-7.

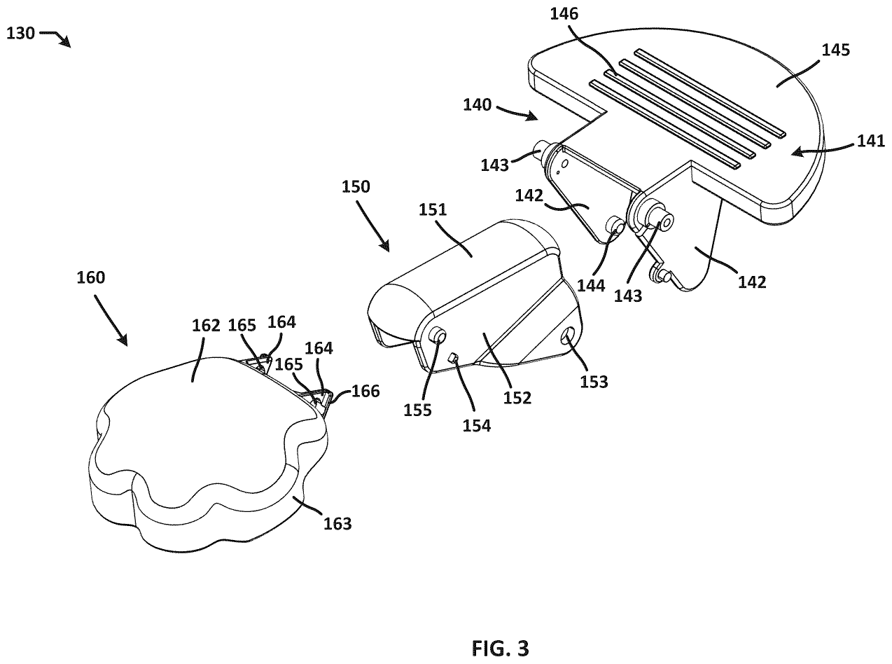

Referring generally to FIGS. 2 and 3, the extendable assembly 130 may include an actuator 140, a linking member 150, and a hollow structure 160. The actuator 140 may be rotatably coupled to the base 110. As best seen in FIG. 3, the actuator 140 may include a body 141 and a pair of spaced apart side walls 142 extending downward from the body 141. The pair of side walls 142 may be disposed parallel to one another. In some examples, the pair of side walls 142 may have the same shape. For example, each of the side walls 142 may have a triangular shape; however, the present disclosure is not limited thereto, and the side walls 142 may have any shape.

As noted above, the actuator 140 may be rotatably coupled to the base 110. In some examples, as shown in FIG. 3, the actuator 140 may include a pair of base pins 143 configured to engage the base 110. As seen in FIG. 3, each of the base pins 143 may extend outward from a respective one of the pair of side walls 142 in a lateral direction (e.g., perpendicular to the axes along which the actuator 140 moves). According to some examples, as shown in FIG. 3, the pair of base pins 143 may be coaxial about an axis perpendicular to the pair of side walls 142.

As shown in FIG. 2, the base 110 may include a pair of sockets 111 (e.g., actuator sockets) configured to receive the base pins 143 extending from the actuator 140 for coupling the actuator 140 to the base 110. The pair of base pins 143 and the pair of sockets 111 may each have a cylindrical shape, such that when the actuator 140 and the base 110 are coupled to one another, the pair of base pins 143 are free to rotate with the pair of sockets 111. The base 110 may include a pair of sockets 111 for each extendable assembly 130 included in the base 110.

The actuator 140 may be rotatably coupled to the linking member 150. As shown in FIG. 3, the actuator 140 may further include a pair of interior pins 144 configured to engage the linking member 150. Each of the pair of interior pins 144 may extend inward from a respective one of the pair of side walls 142 in a lateral direction. For example, each of the pairs of interior pins 144 may extend inward from a respective one of the pair of side walls 142 toward the other of the pair of side walls 142. According to some examples, the pair of interior pins 144 may be coaxial about an axis perpendicular to the pair of side walls 142.

According to the present disclosure, the base pin 143 and the interior pin 144 extending from a respective one of the side walls 142 may be offset from one another. Specifically, the actuator 140 may be rotatably coupled to the base 110 about the base pin 143 disposed at a first location or along a first axis perpendicular to the respective side wall 142 and the actuator 140 may be rotatably coupled to the linking member 150 about the interior pin 144 disposed at a second location or along a second axis perpendicular to the respective side wall 142, the second location and/or axis different than the first location and/or axis. In some examples, the base pin 143 and the interior pin 144 extending from a respective one of the side walls 142 may be offset from one another in the vertical and/or horizontal direction when the actuator 140 is in the starting position or arrangement as shown in FIGS. 2 and 4.

Still referring to FIG. 3, the body 141 of the actuator 140 may include a top surface 145 configured to be pressed or pushed downwards by a pet, for example, operating the extendable assembly 130 causing the extendable assembly 130 to extend into the basin 120 as noted above and described hereinafter in greater detail with respect to FIGS. 4-7. In some examples, as shown in FIG. 3, the body 141 may include a planar top surface 145. Additionally, in some examples, the top surface 145 may include one or more protuberances or ridges 146. The one or more protuberances or ridges 146 may cause the top surface 145 of the body 141 to be textured, thereby preventing a pets paw from slipping relative to the top surface 145 when a pet contacts or presses the top surface 145 of the actuator 140.

As shown in FIG. 3, the linking member 150 may include a top panel 151 and a pair of spaced apart side panels 152 extending downward from the top panel 151. According to some examples, as shown in FIG. 3, the top panel 151 may have a linear or oblong shape; however, the present disclosure is not limited thereto, and the top panel 151 may have any shape.

As shown in FIG. 3, the pair of side panels 152 may be disposed parallel to one another. In some examples, as shown in FIG. 3, each of the pair of side walls 152 may have a trapezoidal shape; however, the present disclosure is not limited thereto, and the side walls 142 may have any shape. As shown in FIG. 3, the linking member 150 may include a pair of actuator holes 153. In some examples, as shown in FIG. 3, each one of the pair of actuator holes 153 may extend through a respective one of the pair of side panels 152. Each of the pair of actuator holes 153 may be configured to receive one of the pair of interior pins 144 extending from the actuator 140, rotatably coupling the actuator 140 and the linking member 150. According to some examples, the pair of actuator holes 153 may be coaxial about an axis perpendicular to the pair of side panels 152.

As shown in FIG. 3, the linking member 150 may further include a post 154 extending from a side panel 152 of the linking member 150. According to the present disclosure, as described in greater detail hereinafter with respect to FIGS. 4-7, the post 154 may cooperate with a guide wall 127 of the bottom panel 121 to control an arrangement of the extendable assembly 130 as the actuator 140 is depressed. As shown in FIG. 3, one of the pair of side panels 152 may include a post 154 extending outward and away from the other of the pair of side panels 152. The post 154 may extend laterally from the side panel 152 in a direction perpendicular to the axes (e.g., vertical and horizontal) along which the linking member 150 moves. In some examples, the linking member 150 may include a pair of posts 154. Specifically, each one of the pair of posts 154 may extend laterally outward from a respective one of the pair of side panels 152. According to some examples, the pair of posts 154 may be coaxial about an axis perpendicular to the pair of side walls 152.

Still referring to FIG. 3, the linking member 150 may further include a pair hollow structure pins 155. The pair of hollow structure pins 155 may be configured to engage the hollow structure 160, for example, facilitating a rotatable connection between the linking member 150 and the hollow structure 160. Each one of the pair of hollow structure pins 155 may extend from a respective side panel 152 of the linking member 150. Each side panel 152 may include a hollow structure pin 155 extending outwardly away from the other of the pair of side panels 152. Further, each post 154 may extend laterally from a respective side panel 152 perpendicular to the axes along which the linking member 150 moves. According to some examples, the pair of hollow structure pins 155 may be coaxial about an axis perpendicular to the pair of side panels 152.

As shown in FIG. 3, the pair of actuator holes 153 and the hollow structure pins 155 may be disposed on opposite ends of the linking member 150. In some examples, the post 154 may be disposed nearer to the end of the linking member 150 including the hollow structure pins 155 than the end of the linking member 150 including the actuator hoes 153. Further, as shown in FIG. 3, the post 154 may be disposed between the actuator hole 153 and the hollow structure pin 155 of a side panel 152 with respect to the horizontal and/or vertical axes.

Still referring to FIG. 3, the hollow structure 160 may include a cover 162 (e.g., hollow structure cover 162) and a bounding wall 163 extending downward from a periphery of the cover 162. As shown in FIG. 3, in some examples, the hollow structure 160 may be shaped to represent the paw of an animal; however, the present disclosure is not limited thereto and the hollow structure 160 may have any shape. As shown in FIG. 2, the hollow structure 160 may further include an internal cavity 161. As described hereinafter in greater detail with respect to FIGS. 4-7, the hollow structure 160 may be configured to rotate to an open position as the actuator 140 is depressed (see FIG. 5), such that food disposed in the basin 120 may be captured within the internal cavity 161 of the hollow structure 160.

Referring generally to FIGS. 2 and 3, the hollow structure 160 may further include a pair of coupling tabs 164. Each of the pair of coupling tabs 164 may extend or protrude from the cover 162 and/or the bounding wall 163 of the hollow structure 160. According to some examples, as best seen in FIG. 2, each of the coupling tabs 164 may have a substantially triangular shape; however, the present disclosure is not limited thereto, and the coupling tabs 164 may have any shape.

As best seen in FIG. 3, the hollow structure 160 may further include a pair of linking member holes 165 configured to receive the hollow structure pins 155 extending from the linking member 150 for coupling the hollow structure 160 and the linking member 150 to one another. In some examples, each one of the pair of linking member holes 165 may extend through a respective one of the coupling tabs 164. As shown, the hollow structure pins 155 and the linking member holes 165 may each have a cylindrical shape, such that when the linking member 150 and the hollow structure 160 are coupled to one another, the pair of hollow structure pins 155 are free to rotate within the pair of linking member holes 165. According to some examples, the pair of linking member holes 165 may be coaxial about an axis perpendicular to the pair of coupling tabs 164. According to some examples, each of the pair of linking member holes 165 may be slightly larger than a hollow structure pin 155 configured to be received by the linking member hole 165, so as to allow for a small amount of movement of the hollow structure pin 155 within a respective linking member hole 165.

Referring generally to FIGS. 2 and 3, each of the pair of coupling tabs 164 may include a cam or angled edge 166. As best shown in FIG. 2, the angled edge 166 may be disposed at an oblique angle with respect to the bottom panel 121 of the basin. As described hereinafter in greater detail with respect to FIGS. 4-7, the angled edge 166 may engage the bottom panel 121 of the basin 120, causing the hollow structure 160 to rotate (e.g., to an open position) as the actuator 140 is depressed.

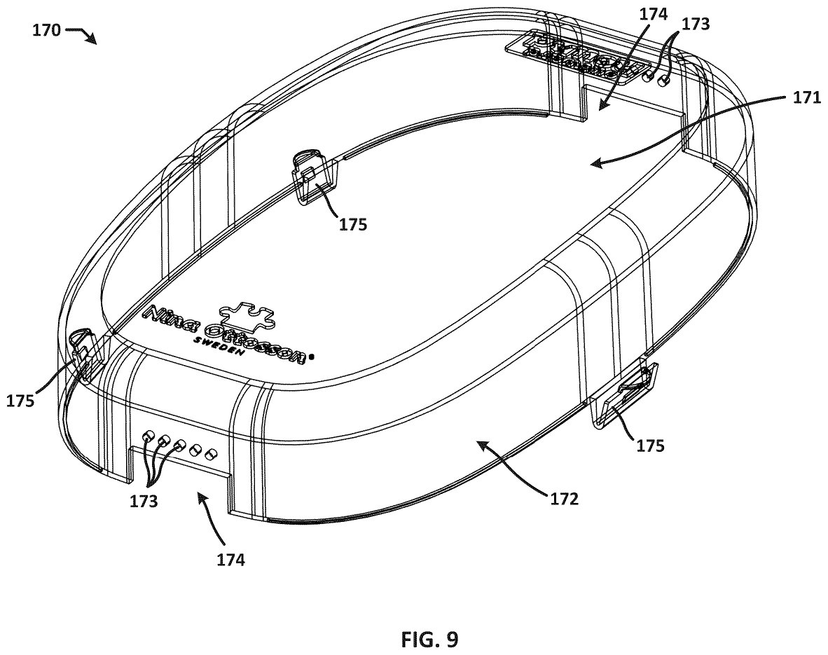

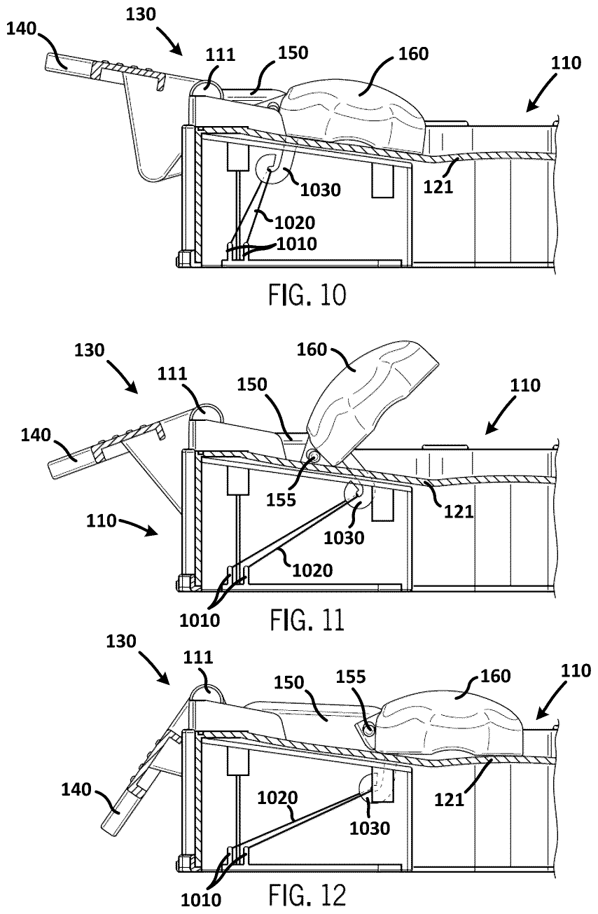

According to some examples, the hollow structure 160 may further include a hook or protrusion and an elastic member, such as a spring or elastic (e.g., rubber) band coupled or attached to the base 110 that may circumscribe or be wrapped around the hook or protrusion of the hollow structure 160. In these examples, as the hollow structure 160 moves toward the center of the basin 120 (e.g., as the extendable assembly 130 moves to the extended arrangement), the elastic member may elastically expand and exert a downward force on the hollow structure 160, such that, for example, when the extendable assembly 130 moves from the extended arrangement to the starting arrangement, a downward force exerted by the elastic member maintains the hollow structure 160 in contact with the bottom panel 121, such that food does not exit or slip out of the internal cavity 161 of the hollow structure 160, as the hollow structure 160 moves away from the center of the basin 120. One example is described below with reference to FIGS. 10-12.

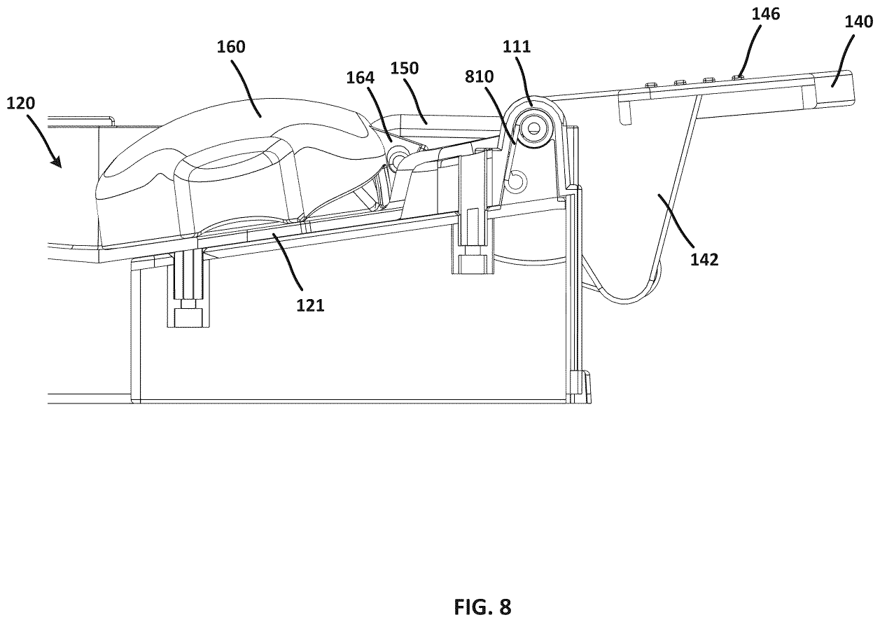

Referring generally to FIGS. 4-7, several partial cross sectional views of the pet toy 100 illustrating a sequence of operating the pet toy 100 are provided in accordance with an example of the present disclosure. Specifically, each of FIGS. 4-7 illustrate an extendable assembly 130 of the pet toy 100 in a different state during an operational sequence of the extendable assembly 130. An operational sequence of the extendable assembly 130 may be one in which an actuator 140 is moved or pressed by a pet (or human) so as to move from a starting position to a completely depressed position, is released (e.g., by the pet) and is moved back to the starting position by a biasing member 810 (see FIG. 8). During each operational sequence the extendable assembly 130 may move from a starting arrangement, as shown in FIG. 4, to an extended arrangement, as shown in FIG. 6, and subsequently back to the starting arrangement.

As noted above, as the extendable assembly 130 moves toward a center of the basin 120 the hollow structure 160 may rotate upward (as shown in FIG. 5) to an open position and subsequently rotate or fall downward (as shown in FIG. 6) so as to capture food disposed within the basin 120 in the internal cavity 161 of the hollow structure 160. Additionally, as the extendable assembly 130 moves or returns from the extended arrangement to the starting arrangement, the hollow structure 160 may remain in a closed state as shown in FIG. 7, such that food captured within the internal cavity 161 of the hollow structure 160 may be hauled or conveyed through the opening 125 and into the chute 180 of the base 110, so as to be dispensed through the outlet 185 of the base 110.

Referring generally to FIGS. 4-7, in some examples, the guide wall 127 may have a trapezoidal cross sectional shape; however, the present disclosure is not limited thereto and a cross sectional shape of the of the guide wall 127 may vary. In some examples, as shown in FIGS. 4-7, a bottom surface 510 of the guide wall 127 may be disposed at an angle. Specifically, the bottom surface 510 at an exterior end 520 of the guide wall 127 may be disposed above the bottom surface 510 at an interior end 530 of the guide wall 127.

FIG. 4 illustrates an extendable assembly 130 of a pet toy 100 in a first state in accordance with one example of the present disclosure. The extendable assembly 130 may begin in an equilibrium or starting arrangement as shown in FIG. 4. The starting arrangement as shown in FIG. 4 is one in which an external (e.g., downward) force is not applied to the actuator 140 of the pet toy 100. As shown in FIG. 4, in the starting arrangement, a post 154 protruding from a side panel 152 of the linking member 150 may be disposed below or at the same height as the guide wall 127. Further, as shown, the post 154 may be disposed behind (e.g., closer to a periphery of the base 110) an exterior end 520 of the guide wall 127. Further, as shown in FIG. 4, in the starting arrangement, the hollow structure 160 may be in a downward or closed position in which the open bottom of the hollow structure 160 abuts the bottom panel 121 and, as such, the internal cavity 161 of the hollow structure 160 is not accessible from the basin 120.

FIG. 5 illustrates the extendable assembly 130 of the pet toy 100 in a second state in accordance with one example of the present disclosure. Specifically, FIG. 5 illustrates the extendable assembly 130 in a state in which the actuator 140 is partially depressed. As shown in FIG. 5, as the actuator 140 is depressed it may rotate about the pair of base pins 143, pushing the linking member 150 toward a center of the basin 120. As the linking member 150 is moved toward the center of the basin 120, a post 154 extending outward from the side wall 152 may contact the bottom surface 510 of guide wall 127. As the linking member 150 moves toward the center of the basin 120, the post 154 may be guided and maintained below the guide wall 127 causing the linking member 150 to move downward. As the linking member 150 is moved downward, the hollow structure pins 155 disposed within the linking member holes 165 may pull the hollow structure 160 downward. As the hollow structure 160 is pulled downward, the angled edge 166 of each of the pair of coupling tabs 164 may be pulled into the bottom panel 121 of the basin 120. As best seen in FIG. 2, the bottom panel 121 of the basin 120 may be disposed below the coupling tabs 164 during the entirety of the operational sequence of the extendable assembly 130. As the angled edge 166 is pulled into the bottom panel 121, the hollow structure 160 may rotate about the angled edge 166 to an open or elevated position as shown in FIG. 5. According to the present disclosure, the hollow structure 160 may rotate to the open position, such that the hollow structure 160 may pass over food (e.g., treats, kibble) disposed in the basin 120, to be captured in the internal cavity 161 of the hollow structure 160 when the hollow structure 160 rotates to the closed position. Specifically, in some examples, as shown in FIG. 5, the angled edge 166 may cause the hollow structure 160 to rotate such that the angled edge 166 is flush with the bottom panel 121 of the basin 120. According to some examples of the present disclosure, an angle of the angled edge may be modified so as to change a degree to which the hollow structure 160 rotates to the open position.

FIG. 6 illustrates the extendable assembly 130 of the pet toy 100 in a third state in accordance with one example of the present disclosure. The extendable assembly 130 may be disposed in an extended arrangement as shown in FIG. 6. The third state and/or extended arrangement of the extendable assembly 130 may be one in which the actuator 140 is completely depressed.

As shown in FIG. 6, when the actuator 140 is completely depressed, the post 154 extending from the linking member 150 has traveled past the interior end 530 of the guide wall 127. After the post 154 moves past the interior end 530 of the guide member 127, the post 154, and thus, the linking member 150 may no longer be restrained or biased downward. Accordingly, as shown in FIG. 6, after passing the interior end 530 of the guide wall 127, the post 154 and the linking member 150 may move upward.

According to some examples, after the post 154 passes the interior end 530 of the guide wall 127, the hollow structure 160 may no longer be pulled downward and the hollow structure 160 may be free to rotate about the hollow structure pins 155 of the linking member 150. In some examples, after the post 154 passes the interior end 530 of the guide wall 127, the weight of the hollow structure 160 may cause the hollow structure 160 to rotate downward to the closed position as shown in FIG. 6. As the hollow structure 160 rotates to the closed position shown in FIG. 6, the food or treats disposed in the basin 120 may be captured within the internal cavity 161 of the hollow structure 160.

FIG. 7 illustrates the extendable assembly 130 of the pet toy 100 in a fourth state in accordance with one example of the present disclosure. Specifically, FIG. 7 illustrates the extendable assembly 130 in a state in which the actuator 140 has been released and the extendable assembly 130 is in the process of returning to the first state and/or starting arrangement as illustrated in FIG. 4.

According to some examples, as shown in FIG. 8, the pet toy 100 may further include a biasing member 810 configured to bias the actuator 140, and thus, the extendable assembly 130 toward the starting arrangement shown in FIG. 4. As shown in FIG. 8, the biasing member 810 may be disposed between a socket 111 of the base 110 and the actuator 140. According to some examples, the biasing member 810 may be a spring, for example, a torsion spring. The biasing member 810 may be configured to elastically deform as the actuator 140 is depressed.

Returning to FIG. 7, after the actuator 140 is released, the biasing member 810 may exert a biasing force on the actuator 140, causing the actuator 140, and thus the extendable assembly 130 to move toward the first state and/or starting arrangement as shown in FIG. 4. According to some examples, as shown in FIG. 7, as the extendable assembly 130 returns to the starting arrangement, the post 154 of the linking member 150 may travel above the guide wall 127 and, as such, the linking member 150 and hollow structure 160 may not be pulled downward and the hollow structure 160 may remain in the closed position as shown in FIG. 7 as the linking member 150 and hollow structure 160 retract or move away from the center of the basin 120.

According to the present disclosure, because the hollow structure 160 remains in a closed position as it retracts or moves away from the center of the basin 120, food captured within the internal cavity 161 may be hauled or moved to the opening 125 in the bottom panel 121 of the basin 120. Food captured within the internal cavity 161 of the hollow structure 160 as described above with respect to FIG. 6 and subsequently hauled or moved to the opening 125 may travel through the opening 125 into the chute 180 and be dispensed from the outlet 185 of the base 110.

Accordingly, as described above with respect to FIGS. 4-7, the shape of the guide wall 127 and a location at which the post 154 extends from the side panel 152 may dictate arrangements of the extendable assembly 130 as the extendable assembly 130 moves from the starting arrangement to the extended arrangement, and subsequently from the extended arrangement back to the starting arrangement. Accordingly, the shape of the guide wall 127 and/or the location at which a post 154 extends from the side panel 152 may be modified so as to change an arrangement of the extendable assembly 130 as it moves to or from the extended arrangement. Specifically, modifying the shape of the guide wall 127 and/or the location at which a post 154 extends from the side panel 152 may change the pathway along which the linking member 150 and/or hollow structure 160 move as the extendable assembly moves to or from the extended arrangement. Specifically, in one example, modifying the length and or angle at which the bottom surface 510 is disposed may change a vertical displacement of the linking member 150 and the hollow structure 160 and thus a degree of rotation of the hollow structure 160 from the closed position to the open position and/or positions along the horizontal axis where the hollow structure 160 begins rotating upward and downward toward the open and closed positions, respectively of the hollow structure 160.

According to some examples, as noted above, the base 110 may include a pair of guide walls 127 and the linking member 150 may include a pair of posts 154. In these examples, the relative relationships and/or interactions between the post 154 and the guide wall 127 as described and illustrated above in FIGS. 4-7 with respect to a single side of the extendable assembly 130 (e.g., single side of the linking member 150) may occur on both sides of the extendable assembly 130.

Referring to FIG. 9, a perspective view of a cover 170 for the pet toy 100 is illustrated in accordance with one example of the present disclosure. As noted above, the cover 170 may be configured to prevent pets from eating or otherwise taking food directly from the basin 120 of the pet toy 100. According to some examples, as shown in FIG. 1, the cover 170 may be comprised of a transparent material, such that a pet (or human) is able to see food or a lack thereof within the basin 120 of the pet toy 100. In some examples, as shown in FIG. 9, the cover 170 may have a dome shape; however, the present disclosure is not limited thereto and the cover 170 may have any shape. For example, the cover 170 may be planar or substantially planar. As shown in FIG. 9, the cover 170 may include a top portion 171 and side portion 172 extending downward from a periphery of the top portion 171.

According to some examples, as shown in FIG. 9, the pet cover 170 may include one or more scent holes 173 extending therethrough. The scent holes 173 may be disposed proximate to a recess 174 disposed in the side portion 172 of the cover 170 at a location corresponding to an extendable assembly 130 when the cover 170 is coupled base 110. The scent holes 173 may be disposed proximate to the recess 174 and may be configured to allow pets to more easily smell food disposed within the basin 120. In some examples, as shown in FIG. 9, a scent hole 173 may be extend through the cover 170 at each of two opposite sides of the side portion 172 of the cover 170, corresponding to sides of the base 110 having an extendable assembly 130.

According to some examples, as shown in FIG. 9, the cover may include one or more protrusions 175 configured to be inserted into respective slots 176 disposed in the base 110 of the pet toy 100 (see FIGS. 1 and 2). According to some examples, each protrusion 175 may include an inner wall and an outer wall configured to be pressed together, elastically deforming as the protrusion is inserted into a respective slot 176 of the base 110, coupling the cover 170 and the base 110. Further, the inner and outer walls of the protrusion may be configured to elastically deform when compressed or pinched by a human, such that the protrusion 175 may be withdrawn from its respective or corresponding slot 176 and the cover 170 may be removed from the base 110. According to other examples, the cover 170 may be removably coupled to the base 110 in other ways. For example, the lid 170 may be rotatably coupled to the base 110 via one or more hinges, so as to rotate between open and closed positions.

Referring generally to FIGS. 10-12, in some examples the base 110 may further include one or more pillars 1010 and an elastic member 1020 coupled to the one or more pillars 1010. In some examples, as shown in FIGS. 10-12, the base 110 may include a pair of pillars 1010 and one end of the elastic member 102 may be coupled to each of the pair of pillars 1010. In other examples, the base 110 may include a single pillar 1010 and the elastic member 1020 may be provided as a loop. In these examples the loop shaped elastic member 1020 may be wrapped around or otherwise coupled to the single pillar 101. The elastic member 1020 may be for example, a spring or elastic (e.g., rubber) band.

As shown in FIGS. 10-12, the hollow structure 160 may further include a protrusion or hook 1030. As shown in FIGS. 10-12, the hook 1030 may be disposed below the bottom panel 121 of the basin 120 and may be configured to engage the elastic member 1020. For example, as shown in FIGS. 10-12, the elastic member 1020 may be wrapped around or disposed within the hook 1030. In other examples, the hook 1030 and elastic member 1020 may be coupled to one another in another way, for example, the elastic member 1020 may be glued or tied to the hook 1030. In yet other examples, one or more fasteners (e.g., screws, bolts, rivets, nails, or the like) may be used to couple the hook 1030 and the elastic member 1020 to one another.

As shown in FIGS. 10-12, the elastic member 1020 may elastically expand (e.g., increase in length) as the hollow structure 160 moves toward a center of the basin 120, for example, as the extendable assembly 130 moves to the extended arrangement. As the elastic member expands, it may exert a downward force on the hollow structure 160, biasing the hollow structure 160 toward a closed position. FIGS. 10-12 illustrate the elastic member in various states during an operational sequence of the extendable assembly 130. As shown in FIG. 10, when the extendable assembly 130 is in the starting arrangement, the elastic member 1020 may be in a first or relaxed state. In some examples, the relaxed state may be an un-stretched state of the elastic member 1030. In other examples, the relaxed state may be a minimally (e.g., least, relative to the states illustrated in FIGS. 10-12) stretched state of the elastic member 1020. The elastic member 1020 may not exert a downward force on the hollow structure 160 or may exert a minimal downward force on the hook structure 160 (e.g., depending on whether the elastic member 1020 is un-stretched or minimally stretched, respectively) in the first state.

As shown in FIG. 11, when the actuator 140 is depressed and the hollow structure 160 rotates to the open position, for example, as the extendable assembly 130 moves toward the extended arrangement, the elastic member 1020 may be in a second or stretched state. Specifically, as shown in FIG. 11, the elastic member 1020 may be in a maximally stretched state, as the hollow structure 160, disposed in the open position, begins rotating to the closed position. The elastic member 1020 may exert a maximal downward force on the hollow structure 160 in the maximally stretched state. As the post 154 of the linking member 150 moves past the interior end 530 of the guide wall 127, as described above with respect to FIG. 6, a downward force applied by the elastic member 1020 of the hollow structure 160 may facilitate closure or rotation of the hollow structure 160 from the open position to the closed position.

As shown in FIG. 12, the elastic member 1020 may be in a third or partially stretched state after the actuator 140 is released and as the extendable assembly 130 travels from the extended arrangement to the starting arrangement. The elastic member 1020 may continue exerting a downward force on the hollow structure 160, such that the hollow structure 160 remains in contact with the bottom panel 121. In this way, food does not exit or slip out of the internal cavity 161 of the hollow structure 160 as the hollow structure 160 moves away from the center of the basin 120.

It should be understood that, although the terms first, second, etc. may be used herein to describe various elements, components, regions, levels, layers, and/or sections, these elements, components, regions, levels, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

For clarity of disclosure, the terms “top,” “upper,” “bottom,” and “lower” are defined herein relative to a position of the base 110 of the pet toy 100 resting on a horizontal surface, such as the ground or floor. The terms “top” and “upper” refer to the position of an element further away from the horizontal surface. The terms “bottom” and “lower” refer to the position of an element closer to the horizontal surface. Further, for clarity of disclosure, the term “interior” as used herein refers to a position closer to a center of the basin 120 or pet toy 100 and the term “exterior” refers to a position further from the center of the basin 120 or pet toy 100 and, for example, closer to a periphery of the basin 120 or pet toy 100.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

While the present disclosure has been described with reference to specific examples, which are intended to be illustrative only and not to be limiting of the disclosure, it should be apparent to those of ordinary skill in the art that changes, additions and/or deletions may be made to the disclosed embodiments without departing from the spirit and scope of the disclosure.

The foregoing description is given for clarity of understanding only, and no unnecessary limitations should be understood therefrom, as modifications within the scope of the disclosure may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

What is claimed is:

1. A pet toy comprising:
a base including a basin and a chute extending from the basin;
a cover removably coupled to the base; and
at least one extendable assembly including an actuator, the at least one extendable assembly configured to extend into the basin toward a center of the basin and capture food for a pet when the actuator is depressed and haul the captured food to the chute when the actuator is released.

2. The pet toy of claim 1, wherein the cover is comprised of a transparent material.

3. The pet toy of claim 1, wherein the cover includes a scent hole.

4. The pet toy of claim 1, wherein the basin includes a bottom panel having an elevated portion disposed at the center of the basin.

5. The pet toy of claim 1, wherein the extendable assembly further comprises:
a linking member rotatably coupled to the actuator; and
a hollow structure configured to capture food when the actuator is depressed and haul the captured food to the chute when the actuator is released rotatably coupled to the linking member,
wherein the actuator is rotatably coupled to the base.

6. The pet toy of claim 5, wherein:
the actuator is rotatably coupled to the base at a first location; and
the actuator is rotatably coupled to the linking member at a second location, the second location different than the first location.

7. The pet toy of claim 5, wherein the basin comprises:
a bottom panel including an opening disposed in the bottom panel adjacent to the chute;
a guide portion extending downward from the bottom panel at the opening; and
a guide wall protruding from the guide portion.

8. The pet toy of claim 7, wherein the linking member comprises:
a top panel;
a pair of side panels extending downward from the top panel; and
a post extending laterally outward from one of the pair of side panels,
wherein the post is configured to contact the guide wall when the actuator is depressed, the guide wall controlling a position of the linking member, and thus, an arrangement of the extendable assembly as the extendable assembly extends toward the center of the basin.

9. A pet toy comprising:
a base including a basin, an outlet, and a chute extending between the basin and the outlet; and
an extendable assembly including:
an actuator rotatably coupled to the base;
a linking member rotatably coupled to the actuator; and
a hollow structure rotatably coupled to the linking member,
wherein the extendable assembly is configured to move from a starting arrangement to an extended arrangement when a downward force is applied to the actuator,
wherein the extendable assembly is configured to move from the extended arrangement to the starting arrangement when the actuator is released, and
wherein the hollow structure is configured to capture food disposed in the basin as the extendable assembly moves from the starting arrangement to the extended arrangement and to haul the captured food to the chute when the extendable assembly moves from the extended arrangement to the starting arrangement.

10. The pet toy of claim 9, wherein the basin comprises:
a bottom panel; and
an opening disposed in the bottom panel adjacent to the chute.

11. The pet toy of claim 10, wherein:
the basin includes a guide portion extending downward from the bottom panel along the opening, the guide portion including a guide wall extending toward a center of the opening;
the linking member includes a post extending laterally from a side of the linking member; and
when the actuator is depressed, the post of the linking member contacts the guide wall, causing the hollow structure to rotate to an open position.

12. The pet toy of claim 11, wherein the hollow structure includes a pair of coupling tabs, each of the pair of coupling tabs configured to be rotatably coupled to the linking member and including an angled edge.

13. The pet toy of claim 12, wherein when the actuator is partially depressed, the post contacts a bottom surface of the guide wall moving the linking member downward, causing the linking member to pull the hollow structure downward, thus causing the hollow structure to rotate about the angled edge of each of the pair of coupling tabs to the open position as the hollowed structure is pulled downward.

14. The pet toy of claim 13, wherein when the actuator is completely depressed, the post travels past the guide wall, the linking member moves upwards, and the hollow structure rotates from the open position to a closed position.

15. The pet toy of claim 13, wherein when the actuator is released from a completely depressed position, the post travels above the guide wall as the extendable assembly moves to the starting arrangement such that the hollow structure remains in a closed position and hauls food disposed within an internal cavity of the hollow structure to the chute.

16. The pet toy of claim 9, wherein the base includes a biasing member disposed between the base and the actuator and configured to bias the extendable assembly to the starting arrangement.

17. A pet toy comprising:
a base including a basin and a chute extending from the basin;
a cover removably coupled to the base; and
a pair of extendable assemblies coupled to the base, each of the pair of extendable assemblies including an actuator and being configured to extend into the basin and capture food for a pet when the actuator is depressed and haul the captured food to the chute when the actuator is released.

18. The pet toy of claim 17, wherein the pair of extendable assemblies are coupled to opposite sides of the base.

19. The pet toy of claim 17, wherein the cover includes at least two scent holes, each of the at least two scent holes extending through the cover at each of two opposite sides of the cover, the opposite sides of the cover corresponding to sides of the base having an extendable assembly.

20. The pet toy of claim 17, wherein the basin includes a bottom panel having an elevated portion disposed at a center of the basin.
